(19) United States
(12) Patent Application Publication
(10) Pub. No.: US 2018/0025406 A1
(43) Pub. Date: Jan. 25, 2018

(54) DETERMINING RECOMMENDATIONS BASED ON USER INTENT

(71) Applicant: INTERNATIONAL BUSINESS MACHINES CORPORATION, Armonk, NY (US)

(72) Inventors: Manish Choudhary, Bangalore (IN); Srinivasan S. Muthuswamy, Bangalore (IN)

(21) Appl. No.: 15/670,027

(22) Filed: Aug. 7, 2017

Related U.S. Application Data
(63) Continuation of application No. 15/213,577, filed on Jul. 19, 2016.

(51) Int. Cl. G06Q 30/06; G06Q 30/02

(52) U.S. Cl. CPC G06Q 30/0631; G06Q 30/0256; G06Q 30/0201

(57) ABSTRACT

According to one or more embodiments, a method, a computer program product, and a computer system for determining recommendations based on user intent are provided. The method may include identifying, by a server computer, one or more nodes. Weight values may be calculated by the server computer for each of the identified nodes, based on analyzing classes of metadata associated with the identified nodes. A web-browsing history of a user corresponding to the identified nodes may be obtained by the server computer. Based on the obtained web-browsing history, a classification may be determined for the user by the server computer, whereby the classification corresponds to one class of metadata associated with the identified nodes. The server computer may select one or more of the identified nodes having a weight value greater than a predetermined threshold value, whereby the selected nodes correspond to the determined classification of the user.

### BACKGROUND

The present invention relates generally to the field of computers, and more particularly to recommender systems.

A recommender system may refer to information filtering that may attempt to predict a rating that a user may assign to an item. For example, a user may assign high ratings to an item based on similar users assigning high ratings to the item or based on the user assigning high ratings to similar items, which may be described as a collaborative filtering system and a content-based filtering system, respectively. Accordingly, a user may be more likely to be purchase items to which they have assigned a high rating. Online shopping, financial services, and online dating, among others, may utilize recommender systems.

### SUMMARY

Embodiments of the present invention disclose a method, system, and computer program product for determining recommendations based on user intent. According to one embodiment, a method for determining recommendations based on user intent is provided. The method may include identifying one or more nodes, such as an item for purchase or a service. A plurality of weights for the one or more identified nodes may be calculated using a dominance graph. A web-browsing history of a user corresponding to the weighted nodes may be obtained, and a plurality of metadata associated with the weighted nodes may be analyzed. Additionally, a classification for the user may be determined from the obtained web-browsing history and the analyzed metadata. A node may then be selected from among the plurality of weighted nodes, whereby the selected node has a higher weight based on the determined classification.

According to another embodiment, a computer system for determining recommendations based on user intent is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include identifying, by a server computer, one or more nodes. Weight values may be calculated by the server computer for each of the identified nodes, based on analyzing classes of metadata associated with the identified nodes. A web-browsing history of a user corresponding to the identified nodes may be obtained by the server computer. Based on the obtained web-browsing history, a classification may be determined for the user by the server computer, whereby the classification corresponds to one class of metadata associated with the identified nodes. The server computer may select one or more of the identified nodes having a weight value greater than a predetermined threshold value, whereby the selected nodes correspond to the determined classification of the user.

According to yet another embodiment, a computer program product for determining recommendations based on user intent is provided. The computer program product may include one or more computer-readable storage devices and program instructions stored on at least one of the one or more tangible storage devices, the program instructions executable by a processor. The program instructions are executable by a processor for performing a method that may accordingly include identifying, by a server computer, one or more nodes. Weight values may be calculated by the server computer for each of the identified nodes, based on analyzing classes of metadata associated with the identified nodes. A web-browsing history of a user corresponding to the identified nodes may be obtained by the server computer. Based on the obtained web-browsing history, a classification may be determined for the user by the server computer, whereby the classification corresponds to one class of metadata associated with the identified nodes. The server computer may select one or more of the identified nodes having a weight value greater than a predetermined threshold value, whereby the selected nodes correspond to the determined classification of the user.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating the steps carried out by a program that determines recommendations based on user intent, according to at least one embodiment;

FIGS. 3A-3B are exemplary views of user intention determination dominance graphs according to at least one embodiment;

FIG. 4 is an exemplary view of a user intention determination dominance graph according to at least one embodiment;

FIG. 5 is a block diagram of internal and external components of computers and servers depicted in FIG. 1 according to at least one embodiment;

FIG. 6 is a block diagram of an illustrative cloud computing environment including the computer system depicted in FIG. 1, according to at least one embodiment; and

FIG. 7 is a block diagram of functional layers of the illustrative cloud computing environment of FIG. 6, according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computers, and more particularly to recommender systems. The following described exemplary embodiments provide a system, method and program product to, among other things, offer recommendations based on user intent. Therefore, the present embodiment has the capacity to improve the technical field of recommender systems by determining the intent of a user. For example, a user may wish to purchase an item for a holiday and may, therefore, be presented with one or more recommendations for items corresponding to the holiday based on a determination of the user's intent by the recommender system.

As previously described, a recommender system may refer to information filtering that may attempt to predict a rating that a user may assign to an item. Online shopping, financial services, and online dating, among others, may utilize recommender systems. However, a recommender system may be, among other things, unable to determine the buyer's intention with respect to an item the buyer wishes to purchase. For example, in a traditional brick-and-mortar store, a buyer is able to interact with a merchant to determine an item to purchase. In online shopping, the recommendations provided may not be tailored to the user and may, therefore, not accurately reflect the buyer's intention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product that offers recommendations based on user intent. According to the present embodiment, recommendations based on user intent may be provided through the creation of a dominance graph to allow, among other things, recommendations to be made by determining a classification (e.g., price, category, sub-category, brand, seller, rating, availability, occasion, event, etc.) and selecting an item having the highest ranking within the determined classification.

According to at least one implementation, the present embodiment may determine recommendations based on user intent. More particularly, the present embodiment may determine a classification based on items that a user had previously viewed and may select an item within the determined classification having a highest ranking.

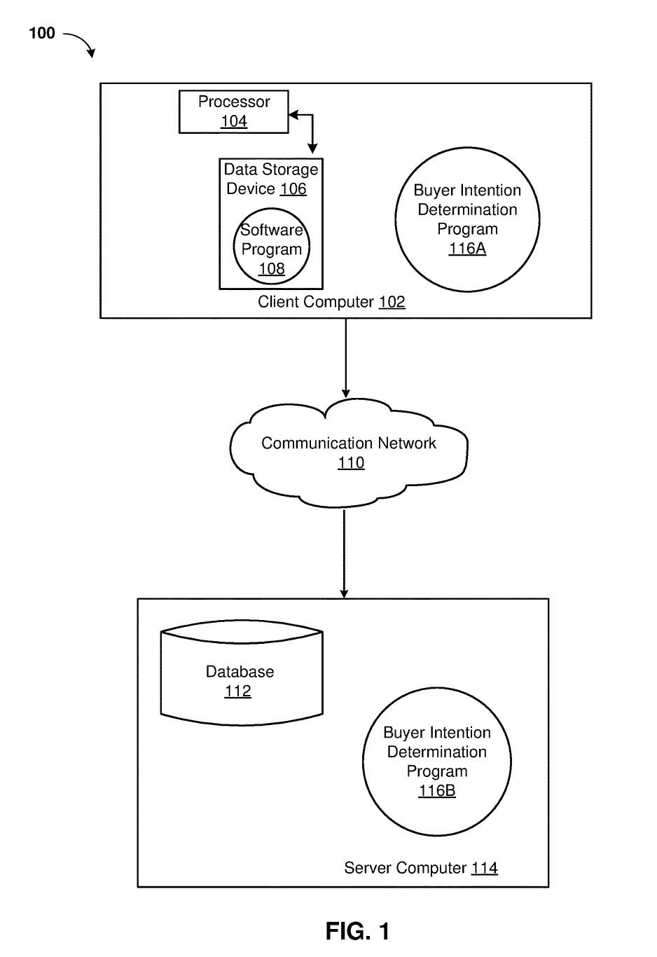

Referring to FIG. 1, an exemplary networked computer environment 100 in accordance with one embodiment is depicted. The networked computer environment 100 may include a client computer 102 with a processor 104 and a data storage device 106 that is enabled to run a software program 108 and a Buyer Intention Determination Program 116A. The networked computer environment 100 may also include a server computer 114 that is enabled to run a Buyer Intention Determination Program 116B that may interact with a database 112 and a communication network 110. The networked computer environment 100 may include a plurality of client computers 102 and server computers 114, only one of which is shown. The communication network may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements. For example, it may be appreciated that the Buyer Intention Determination Program 116B is substantially the same or similar to the Buyer Intention Determination Program 116A. By way of example and not of limitation, the exemplary embodiments disclosed herein will be described with respect to the Buyer Intention Determination Program 116B on the server computer 114. However, any description of the Buyer Intention Determination Program 116B on the server computer 114 may also apply to the Buyer Intention Determination Program 116A on the client computer 102.

It should be noted that the Buyer Intention Determination Program 116B may run primarily on the server computer 114. In an alternative embodiment, the Buyer Intention Determination Program 116B may run primarily on the server computer 114 while additional client computers 102 and server computers 114 may be used for processing data used by the Buyer Intention Determination Program 116B. The processing for the Buyer Intention Determination Program 116B may, in some instances, be shared amongst the client computer 102 and the server computer 114 in any ratio. In another embodiment, the Buyer Intention Determination Program 116B may operate on more than one client computer 102, server computer 114, or some combination of client computers 102 and server computers 114. For example, the Buyer Intention Determination Program 116B may operate on a plurality of client computers 102 connected to a single server computer 114 via the communication network 110.

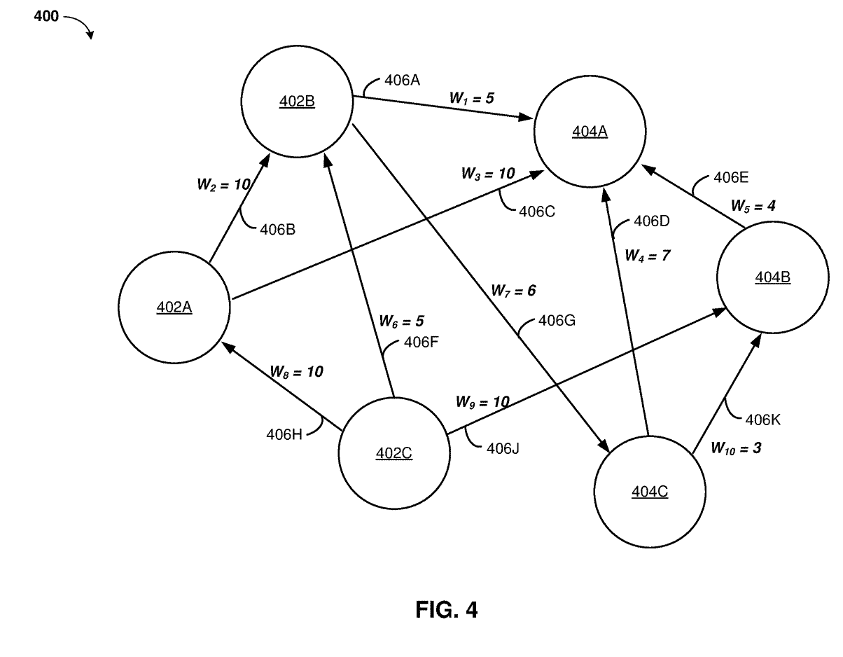

The client computer 102 may communicate with the Buyer Intention Determination Program 116B running on the server computer 114 via the communication network 110. The communication network 110 may include connections, such as wire, wireless communication links, or fiber optic cables. As will be discussed with reference to FIG. 4, the server computer 114 may include internal components 800A and external components 900A, respectively, and the client computer 102 may include internal components 800B and external components 900B, respectively. The server computer 114 may also operate in a cloud computing service model, such as Software as a Service (SaaS), Platform as a Service (PaaS), or Infrastructure as a Service (IaaS), as discussed below. The server computer 114 may also be located in a cloud computing deployment model, such as a private cloud, community cloud, public cloud, or hybrid cloud. The client computer 102 may be, for example, a mobile device, a telephone, a personal digital assistant, a netbook, a laptop computer, a tablet computer, a desktop computer, or any type of computing devices capable of running a program, accessing a network, and accessing a database 112. According to various implementations of the present embodiment, the Buyer Intention Determination Program 116B may interact with a database 112 that may be embedded in various storage devices, such as, but not limited to a computer, a mobile device, a networked server, or a cloud storage service.

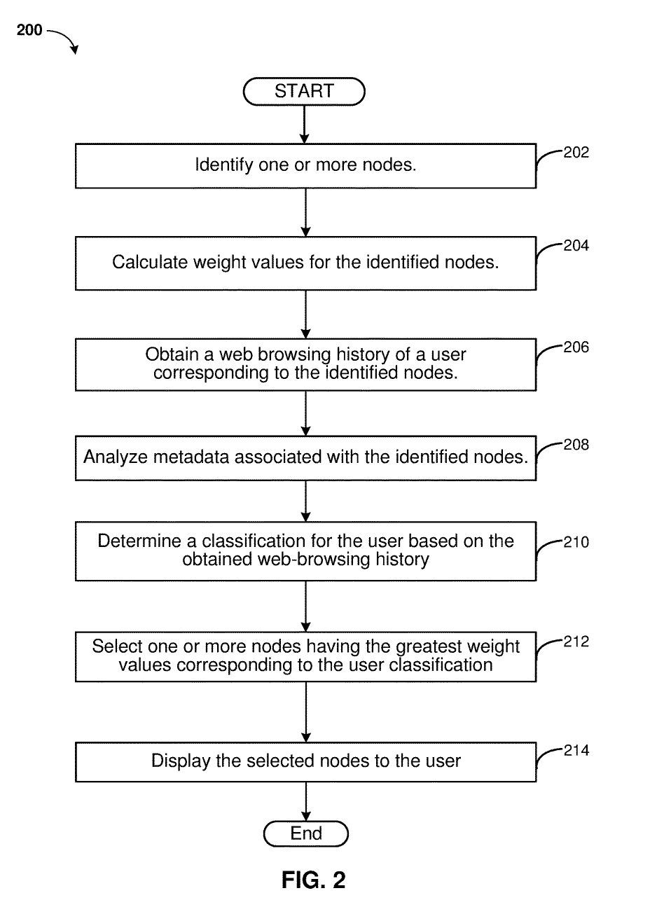

As previously described, the client computer 102 may access the Buyer Intention Determination Program 116B, running on the server computer 114 via the communication network 110. For example, a user using the client computer 102 may utilize the Buyer Intention Determination Program 116B to provide recommendations based on user intent. The Buyer Intention Determination Program method is explained in more detail below with respect to FIG. 2.

Referring to FIG. 2, an operational flowchart 200 illustrating the steps carried out by a program that determines recommendations based on user intent in accordance with one embodiments is depicted. FIG. 2 may be described with the aid of the exemplary embodiment of FIG. 1. As previously described, the Buyer Intention Determination Program 116B (FIG. 1) may provide recommendations based on user intent through analysis of a user's web-browsing history and metadata associated with one or more items viewed by the user.

At 202, one or more nodes are identified by a server computer. In the case of online shopping, the identified nodes may be one or more products for purchase. Alternatively, in the case of online media, the identified node may be movies or songs. According to an exemplary embodiment, the Buyer Intention Determination Program 116B (FIG. 1) on the server computer 114 (FIG. 1) may identify one or more nodes stored on the database 112 (FIG. 1). The one or more identified nodes may correspond to any object that may be of interest to the user, such as a product or media, as discussed above. Any number of nodes may be identified by the Buyer Intention Determination Program 116B from among the database 112.

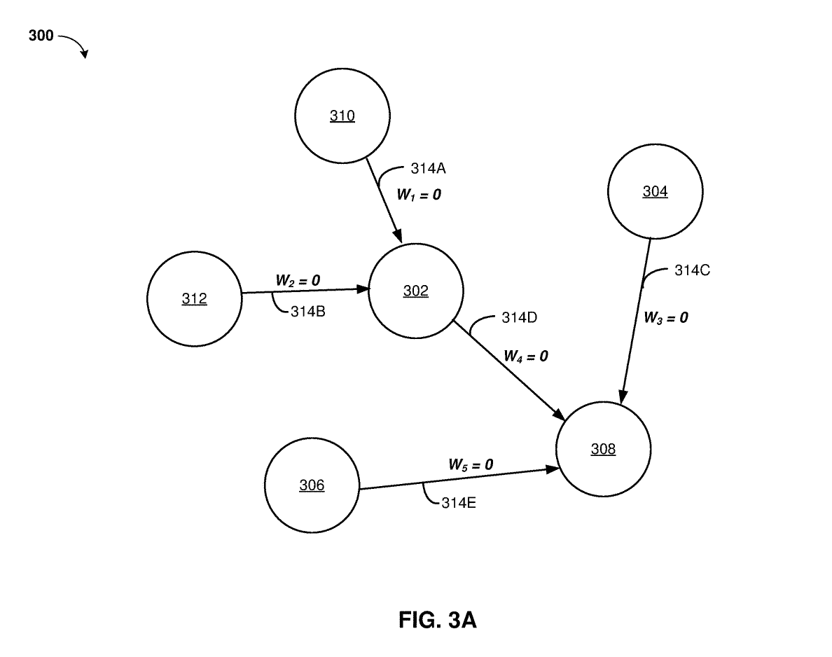

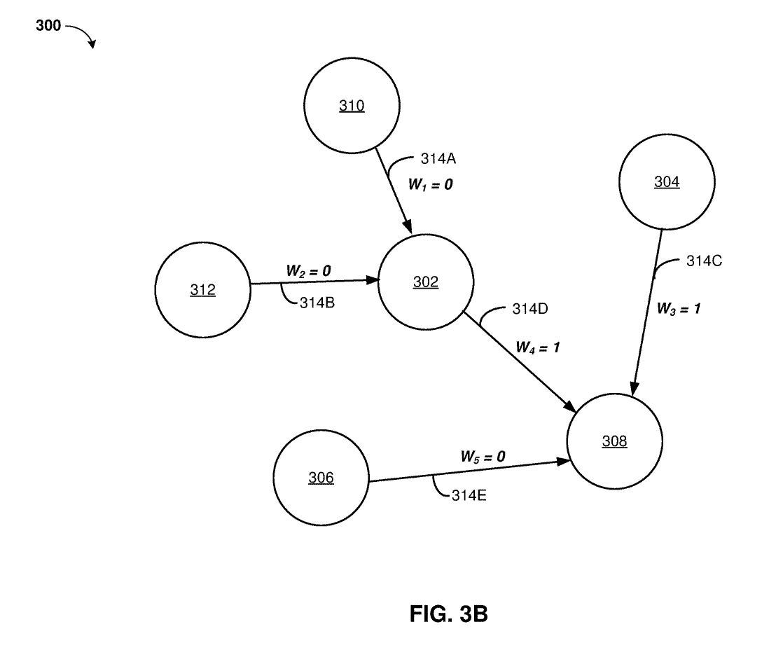

At 204, weight values are calculated for the identified nodes by the server computer. In one exemplary embodiment, the weight values of the identified nodes may be determined using a dominance graph, which will be further described in FIG. 3. In operation, the Buyer Intention Determination Program 116B (FIG. 1) on server computer 114 (FIG. 1) may calculate weight values for each of the identified nodes and store the calculated weights in the database 112 (FIG. 1). The weight values may be calculated based on previous selections of nodes by both the user and by one or more additional users, or any combination thereof. Additionally, the weight values may also be calculated using, among other things, one or more predetermined values stored in the database 112.

At 206, a web-browsing history corresponding to the weighted nodes is obtained by the server computer. According to an exemplary embodiment, the web-browsing history may be obtained through data stored in the database 112 (FIG. 1) on the server computer 114 (FIG. 1). In an alternative embodiment, the web-browsing history may be obtained through browser cookies stored in software program 108 (FIG. 1) on client computer 102 (FIG. 1). The obtained web-browsing history may include, among other things, a list of nodes that have been previously viewed. The web-browsing history may further include a list of nodes that were selected by the user that may have been subsequently selected by the user. It may be appreciated that the web-browsing history may be obtained from either the server computer 114 (FIG. 1) or the client computer 102 (FIG. 1).

At 208, metadata for the weighted nodes is analyzed by the server computer. For example, this metadata may include the node's price, category, sub-category, brand, seller, rating, availability, occasion, event, title, artist, genre, etc. In operation, the Buyer Intention Determination Program 116B (FIG. 1) on server computer 114 (FIG. 1) may obtain metadata for the plurality of nodes. This metadata may either be stored on the database 112 (FIG. 1) on the server computer 114 or may be obtained from an external source via the communication network 110 (FIG. 1). The metadata may be associated with each individual node stored on the database 112. The Buyer Intention Determination Program 116B may then parse and analyze this metadata in order to determine which nodes may, for example, belong to substantially the same category, sub-category, brand, etc. The Buyer Intention Determination Program 116B may then sort the nodes into various groupings based on these identified characteristics.

At 210, a classification for the user is determined from the obtained web-browsing history and the analyzed metadata by the server computer. The Buyer Intention Determination Program 116B (FIG. 1) on the server computer 114 (FIG. 1) may categorize the user into one or more groups based on the analyzed metadata of the previously browsed nodes. Accordingly, the classification for the user may be a classification of the user that may allow the Buyer Intention Determination Program 116B to provide relevant recommendations to the user. The Buyer Intention Determination Program 116B may analyze the viewed nodes and may identify the metadata information from among these nodes that may have, among other things, a highest correlation value. For example, the Buyer Intention Determination Program 116B on the server computer 114 may determine that the user viewed items associated with, for example, a specific holiday (e.g., Christmas) and that the items may fall within a specific price range. Thus, the Buyer Intention Determination Program 116B may classify this user as belonging to the category of the holiday or as belonging to category of the specified price range. It may be appreciated that the user may belong to more than one classification at a time. Accordingly, the Buyer Intention Determination Program 116B may determine which classification most greatly correlates to nodes the user has most recently viewed or is currently viewing.

At 212, one or more weighted nodes having a rank higher than a predefined threshold value based on the determined classification is selected by the server computer. For example, as previously determined, a user may be identified as belonging to a group corresponding to a specific holiday or price range. Thus, one or more nodes corresponding to the highest ranks in these categories may be recommended to be selected the user. In operation, the Buyer Intention Determination Program 116B (FIG. 1) on the server computer 114 (FIG. 1) may select a node from the database 112 (FIG. 1) having the highest rank for the user's determined classification. Alternatively, the Buyer Intention Determination Program 116B may select a plurality of nodes having a weight value that may be greater than a predetermined threshold value stored in the database 112.

At 214, the selected nodes are enabled to be displayed to the user by the server computer. It may be appreciated that the selection may be displayed in any format. In operation, the server computer 114 (FIG.) may transmit one or more nodes from among the highest weighted nodes to the client computer 102 (FIG. 1) via the communication network 110 (FIG. 1). The software program 108 (FIG. 1) on the client computer 102 may then display the received one or more nodes to the user. The user may be, among other things, enabled to select from among these nodes. The selection of one or more nodes may then be transmitted to the server computer 114 via the communication network 110 and stored on the database 112 to be used in future recommendations. It may be appreciated that FIG. 2 provides only an illustration of one implementation and does not imply any limitations with regard to how different embodiments may be implemented. Many modifications to the depicted environments may be made based on design and implementation requirements.

Referring to FIGS. 3A-3B, exemplary views 300 of dominance graphs for intent-based recommender systems in accordance with one embodiment are depicted. With respect to FIG. 3A, an exemplary view of an initialized graph is depicted. A dominance graph for a recommender system may display items as nodes and may display links (e.g., hyperlinks) between the nodes as edges. For example, a dominance graph for an intent-based recommender system may, among other things, identify a plurality of items as nodes 302, 304, 306, 308, 310, and 312, respectively. Additionally, there may be a plurality of directed edges 314A-E between the plurality of nodes 302, 304, 306, 308, 310, and 312. For the purpose of illustration, a finite number of nodes and edges have been shown. However, it may be appreciated that there may be any number of nodes or edges.

Referring to FIG. 3B, an exemplary view of a dominance graph after one or more weights have been assigned, in accordance with one embodiment is depicted. For example, a user may view nodes 302 and 304 and subsequently select node 308. Consequently, weight values W₃ and W₄ corresponding to edges 314C and 314D, respectively, may be incremented by one. Conversely, the user may not have viewed node 306 prior to selecting node 308, and as such, the weight value W₅ may remain unchanged. The weight values for each of the nodes may be determined by calculating the sum total of the weight values of edges leading into each node. For example, the weight value of node 308 may be calculated to be a value of two based on the sum of W₃, W₄, and W₅ being equal to two.

Referring to FIG. 4, an exemplary view 400 of a dominance graph containing nodes from multiple categories is depicted. The dominance graph may include nodes 402A-C that may belong to a first category and nodes 404A-C that may belong to a second category. The dominance graph may also include one or more edges 406A-K that may each have a respective weight value W₁-W₁₀. According to one embodiment, the dominance graph may be used to determine from which category a user may select a node in order to provide a recommendation to the user. For example, a user may first view node 402A and subsequently view node 402C. Thus, it may be determined that the user wishes to select a node from the first category comprising nodes 402A-C. Accordingly, a neighborhood for each of the viewed nodes is determined. For example, the neighborhood for node 402A may be determined to comprise node 402B and node 404A. Additionally, the neighborhood for node 402C may comprise node 402A, node 402B, and node 404B. Thus, since the viewer wishes to select a node from the first category, node 402B may be selected as the node to be shown to the user. It may be appreciated the weight values W₁-W₁₀ may be user to determine the selected node in the event that the respective neighborhoods for the viewed nodes comprise two or more nodes from the same category. It may be further appreciated that the neighborhood may comprise all nodes that that may be reached by traversing any discrete number of edges. For example, if the neighborhood of a node is defined to be all nodes that may be reached by traversing two edges, the neighborhood of node 402C may comprise node 402A, node 402B, node 404A, node 404B, and node 404C.

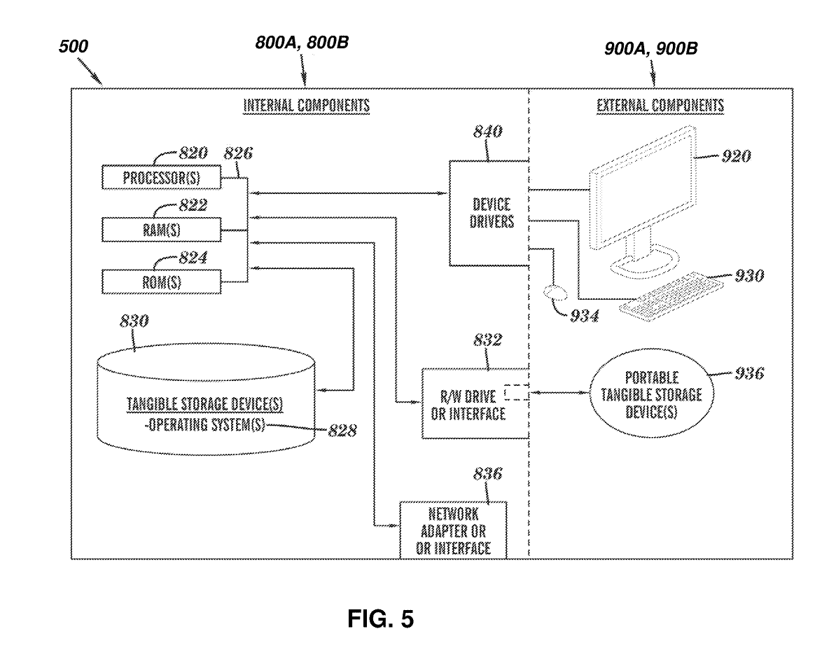

FIG. 5 is a block diagram 500 of internal and external components of computers depicted in FIG. 1 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may be represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Client computer 102 (FIG. 1) and server computer 114 (FIG. 1) may include respective sets of internal components 800A,B and external components 900A,B illustrated in FIG. 4. Each of the sets of internal components 800 include one or more processors 820, one or more computer-readable RAMs 822 and one or more computer-readable ROMs 824 on one or more buses 826, and one or more operating systems 828 and one or more computer-readable tangible storage devices 830. The one or more operating systems 828, the Software Program 108 (FIG. 1) and the Buyer Intention Determination Program 116B (FIG. 1) on server computer 114 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800A,B also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as the Software Program 108 (FIG. 1) and the Buyer Intention Determination Program 116B (FIG. 1) can be stored on one or more of the respective portable computer-readable tangible storage devices 936, read via the respective R/W drive or interface 832 and loaded into the respective hard drive 830.

Each set of internal components 800A,B also includes network adapters or interfaces 836 such as a TCP/IP adapter cards, wireless Wi-Fi interface cards, or 3G or 4G wireless interface cards or other wired or wireless communication links. The Software Program 108 (FIG. 1) and the Buyer Intention Determination Program 116B (FIG. 1) on the server computer 114 (FIG. 1) can be downloaded to client computer 102 (FIG. 1) and server computer 114 (FIG. 1) from an external computer via a network (for example, the Internet, a local area network or other, wide area network) and respective network adapters or interfaces 836. From the network adapters or interfaces 836, the Software Program 108 (FIG. 1) and the Buyer Intention Determination Program 116B (FIG. 1) on the server computer 114 (FIG. 1) are loaded into the respective hard drive 830. The network may comprise copper wires, optical fibers, wireless transmission, routers, firewalls, switches, gateway computers and/or edge servers.

Each of the sets of external components 900A,B can include a computer display monitor 920, a keyboard 930, and a computer mouse 934. External components 900A,B can also include touch screens, virtual keyboards, touch pads, pointing devices, and other human interface devices. Each of the sets of internal components 800A,B also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

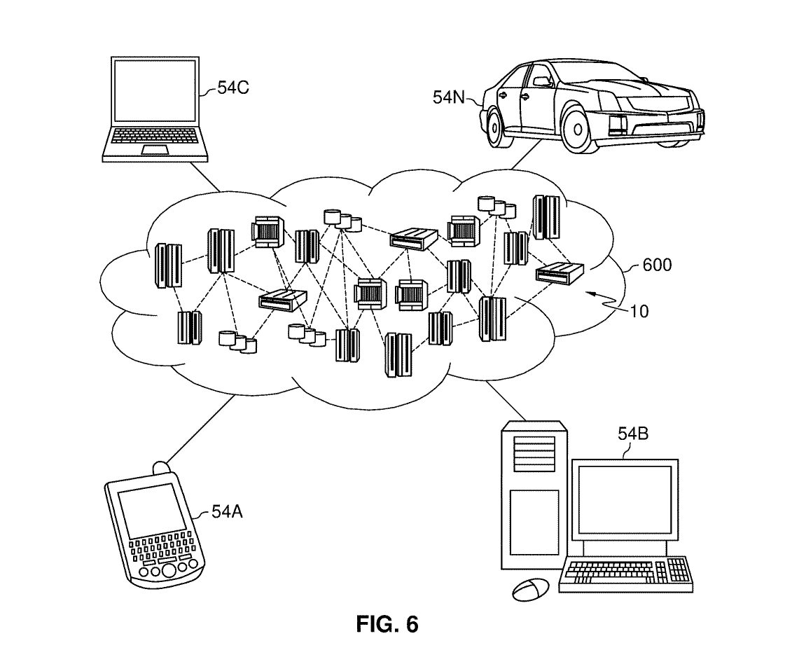

Referring to FIG. 6, illustrative cloud computing environment 600 is depicted. As shown, cloud computing environment 600 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 54A-N shown in FIG. 6 are intended to be illustrative only and that cloud computing nodes 10 and cloud computing environment 600 can communicate with any type of computerized device over any type of network and/or network addressable connection (e.g., using a web browser).

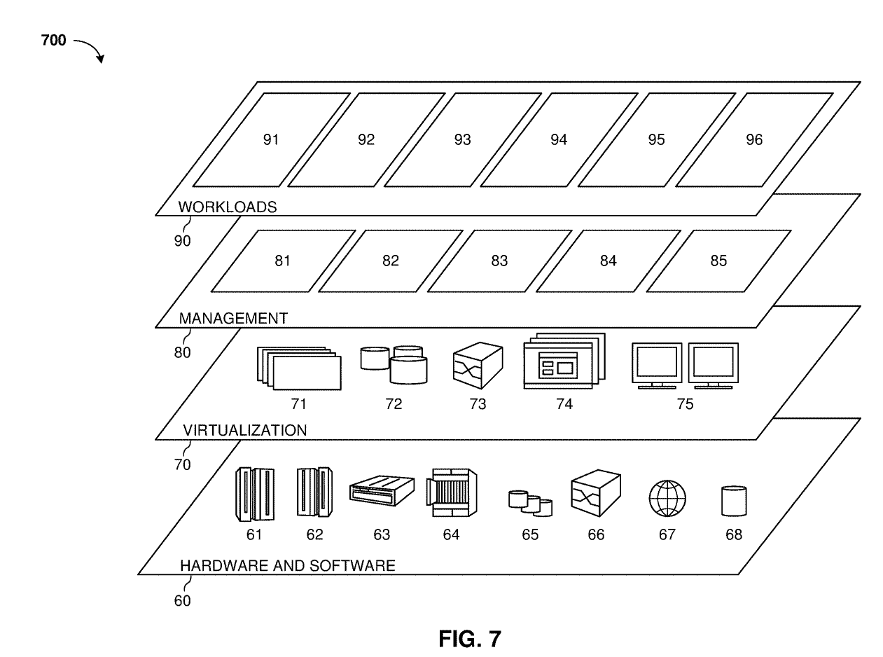

Referring to FIG. 7, a set of functional abstraction layers 700 provided by cloud computing environment 600 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Buyer Intention Determination 96. Buyer Intention Determination 96 may offer one or more recommendations based on a user's intent.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for determining recommendations based on user intent, the method comprising:
identifying one or more nodes, wherein the nodes represent products available for purchase;
identifying edges between each of the identified nodes, wherein the identified edges have an initial weight value of zero;
determining nodes selected by a user from among the identified nodes;
determining nodes viewed by the user associated with each of the nodes selected by the user, wherein the nodes viewed by the user includes only those nodes viewed by the user prior to the user's selection of nodes from among the identified nodes;
incrementing the weight value for all edges between nodes selected by the user and nodes viewed by the user;
calculating a weight value for each node selected by the user, wherein the calculated weight is a sum total of the weight values of all edges associated with each node selected by the user;
obtaining a web-browsing history of the user corresponding to the identified nodes;
organizing (grouping) the identified nodes into groups (classes) based on characteristics identified by analyzing metadata associated with the identified nodes;
identifying one group of the organized groups corresponding to the user based on the obtained web-browsing history;
selecting one or more of the identified nodes from the identified group having a weight value greater than a predetermined threshold value; and
displaying the one or more selected nodes to the user.
